(19) United States
(12) Patent Application Publication
(10) Pub. No.: US 2004/0167924 A1
(43) Pub. Date: Aug. 26, 2004

(54) Information processing method, information processing apparatus, and distributed processing system

(75) Inventor: Tsuyoshi Kuroki, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/779,690

(22) Filed: Feb. 18, 2004

(30) Foreign Application Priority Data
Feb. 21, 2003 (JP) 2003-044487

(51) Int. Cl. G06F 7/00

(52) U.S. Cl. 707/103 R

(57) ABSTRACT

A server in an object-oriented distributed processing system has a computer ID management section which assigns a unique computer ID to each of all computers (clients) in the system. A client receives the computer ID from the computer ID management section in first connection to the server and then generates an object having an object ID generated by using the computer ID. Accordingly, the client need not acquire the computer ID in every object generation processing. Hence, an object can quickly be generated.

### FIELD OF THE INVENTION

The present invention relates to a distributed processing technique and, more particularly, to a technique for executing object-oriented distributed processing.

### BACKGROUND OF THE INVENTION

In recent years, object-oriented computer systems (object-oriented systems), which describe a program by a set of objects defined by attribute values (properties) and functions (methods) for them, are used for various application purposes. An object-oriented system executes processing as a whole while causing a plurality of objects to mutually use their functions. Currently, many object-oriented distributed processing systems (to also be simply referred to as a distributed processing system hereinafter) are used, in which a plurality of computers are connected through a network, and objects that exist on the computers communicate with each other and execute processing in cooperation.

In such a distributed processing system, when an object wants to request another object to execute processing, an object ID as the identifier of the partner object and a function name must be designated. To do this, in an object-oriented distributed processing system, IDs unique to all objects on all computers that exist on the system must be defined.

If the computers that exist on the system arbitrarily define object IDs, objects having the same ID may be generated on different computers. To prevent this, many object-oriented distributed processing systems have a server that manages all objects on all computers. When each computer (client) connected to the server should generate an object, an object generation request is transmitted to the server. The server issues a unique object ID and transmits it to the client. Upon receiving the object ID, the client generates an object. With this arrangement, generation of the same object ID is prevented.

More specifically, in an object-oriented system using a server that manages all objects on all computers on a network, if a client wants to generate a new object, the following object generation procedures must be executed.

1. The client transmits an object generation request message to the server.

2. Upon receiving the object generation request message, the server generates a non-duplicate (unique) object ID and distributes it to the client.

3. The client generates a new object by using the object ID received from the server.

As described above, when a client wants to generate an object, message switching with the server is always necessary. If the time consumed by message switching is long, the object generation time is also long. When the communication speed between the server and the client is high, then the problem of delay caused by communication is not especially serious. If the communication speed is low, however, the delay cannot be ignored. Additionally, the delay in object generation may be an obstacle for the user or the application.

### SUMMARY OF THE INVENTION

The present invention has been made in consideration of the above-described problems of prior art, and has as its main object to provide an information processing apparatus and information processing method which can generate a new object without communicating with a server in an information processing apparatus which can generate an object and be connected to another computer through a network to form a distributed processing system.

Another main object of the present invention is to provide a management information processing apparatus and an information processing method which can suitably be used as a server in a distributed processing system using the information processing apparatus of the present invention as a client.

Another main object of the present invention to provide a distributed processing system which uses the information processing apparatus and the management information processing apparatus according to the present invention.

According to an aspect of the present invention, an information processing method in an information processing apparatus which can generate an object and can be connected to another information processing apparatus through a network to form a distributed processing system, characterized by comprising: an acquisition step of acquiring unique information from the other information processing apparatus; and an identification information generation step of, in generating an object, generating identification information of the object by using the unique information.

According to another aspect of the present invention, an information processing method in a management information processing apparatus which manages information processing apparatuses included in a distributed processing system, characterized by comprising: a unique information assigning step of assigning unique information to each of the information processing apparatuses; and a notification step of sending information about an object received from one of the information processing apparatuses to the remaining information processing apparatuses.

According to a further aspect of the present invention, an information processing method in an information processing apparatus which constitutes a distributed processing system, characterized by comprising steps of: acquiring a unique ID from a management information processing apparatus which manages IDs of all information processing apparatuses that constitute the distributed processing system; generating an object ID by using the acquired unique ID; and transmitting object information containing the object ID to the remaining information processing apparatuses in the distributed processing system.

According to still further aspect of the present invention, a computer program which causes a computer apparatus to execute an information processing method of the present invention or a computer-apparatus-readable storage medium which stores the computer program.

According to yet further aspect of the present invention, an information processing apparatus which can generate an object and can be connected to another information processing apparatus through a network to form a distributed processing system, characterized by comprising: acquisition unit adapted to acquire unique information from the other information processing apparatus; and identification information generation unit adapted to, in generating an object, generate identification information of the object by using the unique information.

According to another aspect of the present invention, a management information processing apparatus which manages information processing apparatuses included in a distributed processing system, characterized by comprising: unique information assigning unit adapted to assign unique information to each of the information processing apparatuses; and notification unit adapted to send information about an object received from one of the information processing apparatuses to the remaining information processing apparatuses.

According to another aspect of the present invention, an information processing apparatus which constitutes a distributed processing system, characterized by comprising: unit adapted to acquire a unique ID from a management information processing apparatus which manages IDs of all information processing apparatuses that constitute the distributed processing system; unit adapted to generate an object ID by using the acquired unique ID; and unit adapted to transmit object information containing the object ID to the remaining processing apparatuses in the distributed processing system.

According to another aspect of the present invention, a distributed processing system characterized by comprising: a plurality of information processing apparatuses, each information processing apparatus comprising acquisition unit adapted to acquire unique information from another information processing apparatus connected through a network, object generation unit adapted to generate an object, and identification information generation unit adapted to, in generating the object, generate identification information of the object by using the unique information, and a management information processing apparatus which manages the plurality of information processing apparatuses, the management information processing apparatus comprising unique information assigning unit adapted to assign unique information to each of the plurality of information processing apparatuses, and notification unit adapted to send information about an object received from one of the plurality of information processing apparatuses to the remaining information processing apparatuses.

According to another aspect of the present invention, a distributed processing system constituted by a plurality of information processing apparatuses connected through a network, and a management information processing apparatus which manages a unique ID of each of the plurality of information processing apparatuses, characterized in that each of the plurality of information processing apparatuses comprises unit adapted to acquire a unique ID of its own from the management information processing apparatus, unit adapted to generate an object ID by using the acquired unique ID, and unit adapted to transmit object information containing the object ID to the remaining information processing apparatuses in the distributed processing system.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the arrangement of an object-oriented distributed processing system according to the embodiment of the present invention;

FIG. 2 is a view schematically showing part of the arrangement shown in FIG. 1;

FIG. 3 is a sequence chart for explaining processing procedures when a client is connected to the server;

FIG. 4 is a sequence chart for explaining procedures in object generation; and

FIG. 5 is a sequence chart for explaining procedures for processing an object.

### DETAILED DESCRIPTION OF THE PREFERRED EMBODIMENT

A preferred embodiment of the present invention will now be described in detail in accordance with the accompanying drawings.

An example will be described below in which an object-oriented distributed processing system which uses an information processing apparatus according to the present invention as a client and a management information processing apparatus as a server is applied to execute an application that causes a plurality of users to share one virtual space. In this application, each of the virtual objects existing in the virtual space is expressed as an object. The avatar of the user of each client in the system is also an object in the virtual space. At each client, the vision in the virtual space seen from the user's avatar (the viewpoint of the user's avatar) is rendered by CG and presented to the user through a display device such as an HMD. Each user can generate or move a virtual object (object) such as a sphere or cube in the virtual space by using an input device such as a joystick, mouse, or keyboard.

The information of each virtual object (object) that is present in the virtual space is shared by all clients. Object manipulation (generation) executed by a given client is reflected on the display at the remaining clients.

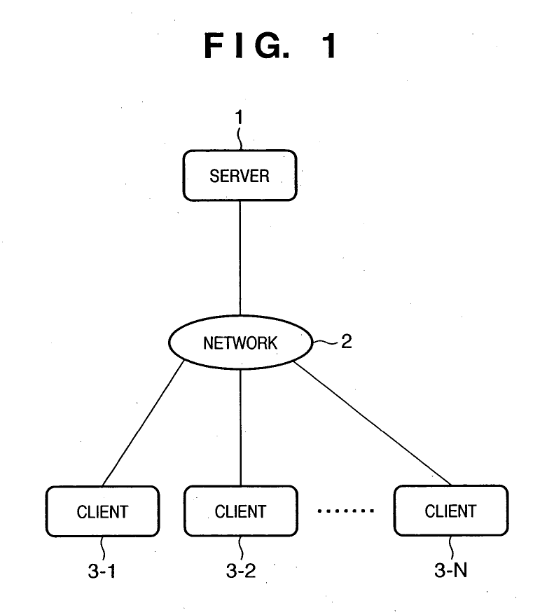

FIG. 1 is a view showing the arrangement of an object-oriented distributed processing system according to the embodiment of the present invention. A server 1 manages the IDs of all computers connected to a network 2. Clients 3-1 to 3-N serving as computers are connected to the network 2. The server 1 and clients 3-1 to 3-N can communicate with each other through the network 2.

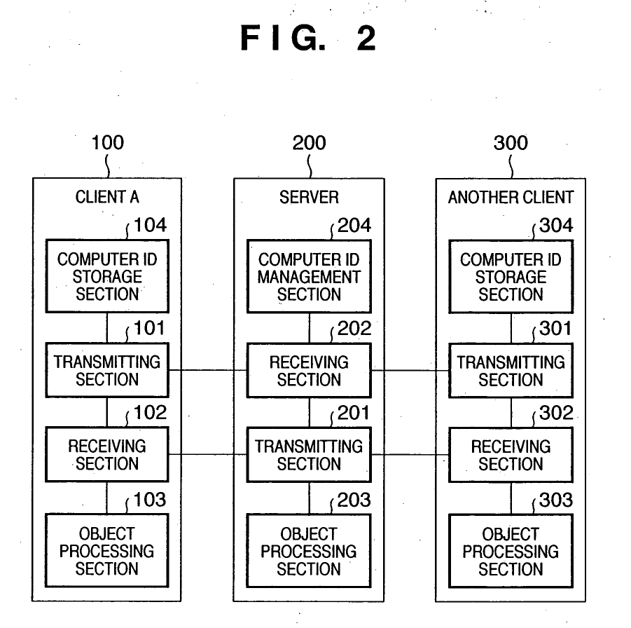

FIG. 2 is a view in which the arrangement shown in FIG. 1 is expressed by a client A 100, another client 300, and server 200. As described above, the clients and server can communicate with each other through the network 2. In object generation (manipulation) processing, the clients do not execute direct communication therebetween and instead exchange information through the server. Hence, the arrangement is expressed as shown in FIG. 2 for the illustrative and descriptive convenience to help understanding of the operation.

Both the client and the server are implemented by a general-purpose computer apparatus which has a CPU, ROM, RAM, display card, input and output cards (network interface, serial interface, and the like), hard disk drive, optical drive, and the like, and input and output devices (input devices such as a keyboard, mouse, and joystick and output devices such as a display device and printer). Each functional block shown in FIG. 2 is implemented actually by causing the CPU to execute a program stored in a nonvolatile storage device such as a ROM or HDD and control the sections of the apparatus.

The client A 100 has a transmitting section 101, receiving section 102, object processing section 103, and computer ID storage section 104. The server 200 has a transmitting section 201, receiving section 202 object processing section 203, and computer ID management section 204.

Each of the remaining clients 300 also has the same arrangement as that of the client A 100.

The transmitting section 101 transmits a request or object information from the client A 100 to the receiving section 202 of the server 200. The receiving section 102 receives a request or object information from the server 200. The object processing section 103 generates an object, executes processing for an object in the client A itself, requests processing for an object in another computer, or renders an object that exists in the virtual space shared by the system. The computer ID storage section 104 stores a computer ID received from the server 200.

The sections of the server 200 are hereby described, as follows. The transmitting section 201 transmits a request or object information to a client to the receiving section of the appropriate client. The receiving section 202 receives a request or object information from each client. The object processing section 203 executes the function of an object in the server 200 itself or requests processing for an object in another computer. The computer ID management section 204 manages the IDs of all computers that are present on the system. In this embodiment, the server 200 also serves as a client.

The computer ID is hereby described, as follows. The computer ID is an ID uniquely assigned to each of the computers that build the object-oriented distributed processing system. Issue and management of IDs are executed by the server 200. A computer ID is uniquely defined, and for this reason, when a computer ID is designated, the computer having that computer ID can be specified.

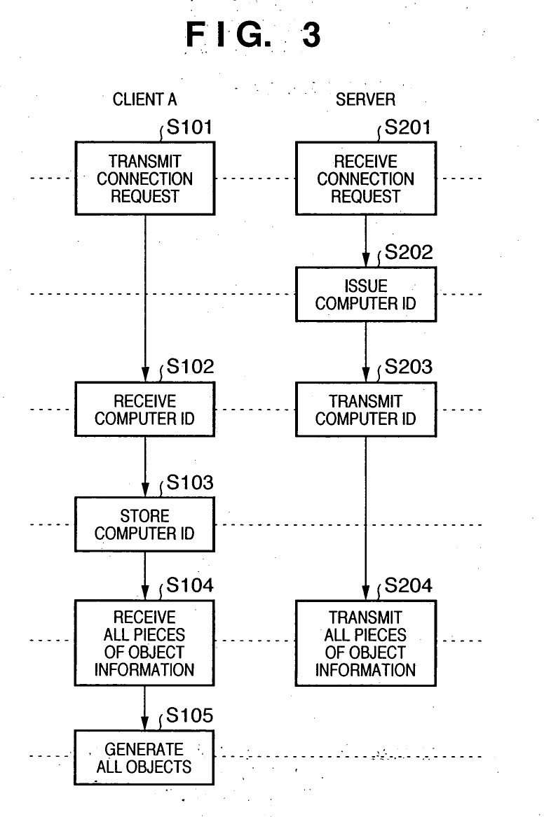

Computer IDs are decided by the server 200. To do this, any method capable of assigning a unique ID to each computer can be used. For example, serial IDs are assigned to clients in the order of connection to the server. The flow of this processing will be described with reference to FIG. 3.

In step S101, the client A 100 causes the transmitting section 101 to transmit a connection request for the server 200. The server 200 causes the receiving section 202 to receive the connection request and send it to the computer ID management section 204. In step S202, the computer ID management section 204 issues an ID unique to the client A and sends the computer ID to the transmitting section 201. In step S203, the transmitting section 201 transmits the computer ID to the client A. In step S102, the client A causes the receiving section 102 to receive the computer ID, and the computer ID received is then sent to the computer ID storage section 104. In step S103, the computer ID is stored in the computer ID storage section 104.

A method of assigning a computer ID to a client has been described above, and the server 200 may assign a computer ID to itself (e.g., the server 200 may assign ID “0” to itself). A computer having a computer ID may be a virtual computer, as well (e.g., when two virtual clients are present on a single computer, a computer ID is assigned to each of the virtual clients).

In the case described above, the computer ID management section 204 in the server 200 stores, e.g., the maximum value of issued computer IDs in a memory or counter. When a connection request is received, a value obtained by adding “1” to the maximum value is issued as a computer ID, and the stored maximum value is incremented by one.

In step S204, the object processing section 203 in the server 200 sends pieces of information of all objects which are present in the virtual space shared by the system to the receiving section 102 of the client A through the transmitting section 201. In step S104, the client A 100 receives the pieces of information of all objects and sends them to the object processing section 103. In step S105, all objects are generated by the object processing section 103. Necessary objects are rendered on a display device (not shown) on the basis of their conditions, such as the user's viewpoint or a user operation on an input device.

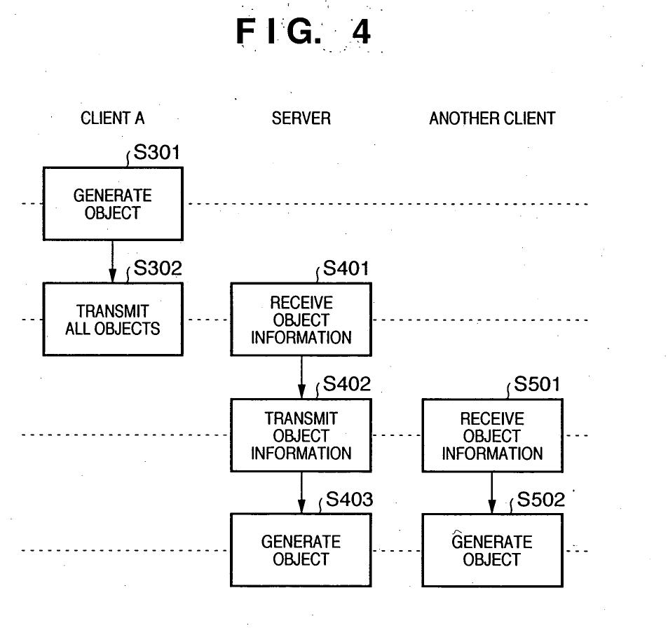

Procedures for generating an object in the object-oriented distributed-processing system according to this embodiment will be hereinafter described with reference to FIG. 4.

First, procedures in the client A are described. In step S301, the client A 100 causes the object processing section 103 to generate an object present in the virtual space in response to, e.g., a user operation. At this time, attribute values such as the color and size of the object are generated as object information. Additionally, an object ID is generated. To prevent generation of an object ID that is the same as that generated by another client, the object ID is generated in accordance with the following procedures:

Assuming that an object ID is represented by a 32-bit integral value;

1. A variable local_id is prepared, which is initialized to 0 and incremented by one every time an object is generated by the client A 100;

2. A computer ID is set in 8 higher bits; and

3. The variable local_id is set in the 24 lower bits.

When the object ID is generated in accordance with the above procedures, the resultant object ID never has the same value as that of an object generated by another client. As long as it is guaranteed that the object ID never has the same value as that generated by another client, any other method can be used to generate an object ID. However, the generated object ID preferably makes it possible to specify, on the basis of it, the computer that has generated the corresponding object. The computer ID need not be contained in the object ID in its original form. The form of the computer ID may be obtained by certain conversion processing.

When the computer ID is embedded in specific bits of the object ID, as described above, the computer that has generated the object can be specified only by referring to the object ID. In the above example, the computer that has generated the object can be specified by referring to the 8 higher bits of the object ID. Such an object ID is effective especially when a standalone object-oriented system is made to deal with distributed processing.

When an object is thus generated in step S301, in step S302, the pieces of information (information such as attributes necessary for causing another client to generate an object, the object ID, and the computer ID (the computer ID is unnecessary when it can be specified from the object ID)) of the generated object are transmitted from the transmitting section 101 to the server.

Object generation procedures in the server are hereinafter described. In step S401, the transmitting section 201 receives object information. In step S402, the object information is directly transmitted from the transmitting section 201 to another client. In step S403, the object processing section 203 generates an object on the basis of the received object information.

In another client, in step S501, a receiving section 302 receives the object information. In step S502, an object processing section 303 generates an object on the basis of the received object information. The object is rendered on a display device (not shown), as needed, on the basis of conditions such as the user's viewpoint and a user operation on an input device.

The object generation procedures have been described above. With the above technique, the client A 100 can generate an object without communicating with the server. Hence, the client can generate an object without being influenced by the delay in the network. Even in the server and another client, an object having the same object ID as that in the client A 100 is generated.

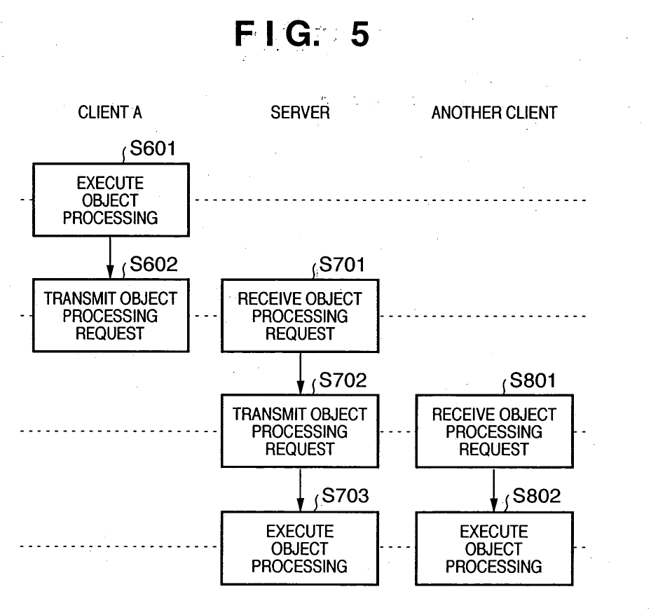

The procedures of object processing for executing the function of an object in this embodiment are hereinafter described with reference to FIG. 5. In this embodiment, all computers are notified of object processing (manipulation, generation, and function execution) generated in a given computer. In addition, all computers have information about all of the objects in the virtual space. Hence, object processing executed in a given computer is also executed in all the remaining computers. For this reason, all the computers can share a single virtual space.

In step S601, the client A 100 causes the object processing section 103 to execute object processing in response to, e.g., a user operation. In step S602, an object processing request is transmitted from the transmitting section 101 to the server 200. The object processing request contains information, including the object ID, necessary for other computers to execute the same object processing as that executed by the client A 100.

In step S701, the server 200 causes the receiving section 202 to receive the object processing request. In step S702, the object processing request is transmitted from the transmitting section 201 to another client. In step S703, the object processing section 203 executes object processing.

In step S801, the client 300 causes the receiving section 302 to receive the object processing request. In step S802, the object processing section 303 executes object processing.

With the above procedures, all computers can execute the same object processing.

As described above, and according to this embodiment, in an object-oriented system constituted by a plurality of computers, each client can immediately generate an object without communicating with the server in every object generation processing. Hence, the system can even cope with an application sensitive to a delay in object generation. The effect of this arrangement is especially large in an application that generates and processes an object almost simultaneously.

Additionally, because information of an object that has undergone processing such as generation is sent to the remaining computers through the server, all the computers can execute the same processing.

<Other Embodiments>

Note that the present invention can be applied to an apparatus comprising a single device or to a system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As described above, according to the present invention, a client in an object-oriented distributed processing system generates an object ID by using a computer ID which is received in first connection to the server. Hence, the client can generate an object having an ID which never has the same value as that of an object generated by another client without communicating with the server every time a new object should be generated.

As many apparently widely different embodiments of the present invention can be made without departing from the spirit and scope thereof, it is to be understood that the invention is not limited to the specific embodiments thereof except as defined in the appended claims.

What is claimed is:

1. An information processing method in an information processing apparatus which can generate an object and can be connected to another information processing apparatus through a network to form a distributed processing system, characterized by comprising:
an acquisition step of acquiring unique information from the other information processing apparatus; and
an identification information generation step of, in generating an object, generating identification information of the object by using the unique information.

2. The method according to claim 1, characterized in that the other information processing apparatus from which the unique information is acquired is a management information processing apparatus which manages pieces of unique information of all information processing apparatuses that form the distributed processing system.

3. The method according to claim 2, characterized by further comprising a notification step of sending information, including the identification information, about an object which has undergone object processing including generation to the management information processing apparatus.

4. The method according to claim 2, characterized by further comprising
a reception step of receiving information about an object processed by the other information processing apparatus, and
an object processing step of executing the same object processing as that of the other information processing apparatus on the basis of the received information.

5. An information processing method in a management information processing apparatus which manages information processing apparatuses included in a distributed processing system, characterized by comprising:
a unique information assigning step of assigning unique information to each of the information processing apparatuses; and
a notification step of sending information about an object received from one of the information processing apparatuses to the remaining information processing apparatuses.

6. The method according to claim 5, characterized by further comprising an object processing sep of executing the same object processing as that of one of the information processing apparatuses on the basis of the information about the object.

7. An information processing method in an information processing apparatus which constitutes a distributed processing system, characterized by comprising steps of:
acquiring a unique ID from a management information processing apparatus which manages IDs of all information processing apparatuses that constitute the distributed processing system;
generating an object ID by using the acquired unique ID; and
transmitting object information containing the object ID to the remaining information processing apparatuses in the distributed processing system.

8. A computer program which causes a computer apparatus to execute an information processing method of claim 1.

9. A computer-apparatus-readable storage medium which stores a computer program of claim 8.

10. An information processing apparatus which can generate an object and can be connected to another information processing apparatus through a network to form a distributed processing system, characterized by comprising:
acquisition unit adapted to acquire unique information from the other information processing apparatus; and
identification information generation unit adapted to, in generating an object, generate identification information of the object by using the unique information.

11. A management information processing apparatus which manages information processing apparatuses included in a distributed processing system, characterized by comprising:
unique information assigning unit adapted to assign unique information to each of the information processing apparatuses; and
notification unit adapted to send information about an object received from one of the information processing apparatuses to the remaining information processing apparatuses.

12. An information processing apparatus which constitutes a distributed processing system, characterized by comprising:
unit adapted to acquire a unique ID from a management information processing apparatus which manages IDs of all information processing apparatuses that constitute the distributed processing system;
unit adapted to generate an object ID by using the acquired unique ID; and
unit adapted to transmit object information containing the object ID to the remaining processing apparatuses in the distributed processing system.

13. A distributed processing system characterized by comprising:
a plurality of information processing apparatuses, each information processing apparatus comprising
acquisition unit adapted to acquire unique information from another information processing apparatus connected through a network,
object generation unit adapted to generate an object, and
identification information generation unit adapted to, in generating the object, generate identification information of the object by using the unique information, and
a management information processing apparatus which manages the plurality of information processing apparatuses, the management information processing apparatus comprising
unique information assigning unit adapted to assign unique information to each of the plurality of information processing apparatuses, and
notification unit adapted to send information about an object received from one of the plurality of information processing apparatuses to the remaining information processing apparatuses.

14. A distributed processing system constituted by a plurality of information processing apparatuses connected through a network, and a management information processing apparatus which manages a unique ID of each of the plurality of information processing apparatuses, characterized in that each of the plurality of information processing apparatuses comprises
unit adapted to acquire a unique ID of its own from the management information processing apparatus,
unit adapted to generate an object ID by using the acquired unique ID, and
unit adapted to transmit object information containing the object ID to the remaining information processing apparatuses in the distributed processing system.
